(19) United States
(12) Patent Application Publication
(10) Pub. No.: US 2016/0052158 A1
(43) Pub. Date: Feb. 25, 2016

(54) GUIDE BAR RETENTION SYSTEMS AND TECHNIQUES

(71) Applicant: Blount, Inc., Portland, OR (US)

(72) Inventor: Lance Luedtke, Vancouver, WA (US)

(21) Appl. No.: 14/464,173

(22) Filed: Aug. 20, 2014

(51) Int. Cl. B27B 17/02

(52) U.S. Cl. CPC B27B 17/02

(57) ABSTRACT

Disclosed herein are systems and methods for securing a guide bar to a chainsaw body. In some embodiments, a chainsaw may include a mounting stud, a side cover and the retention member. The mounting stud may extend away from a bar mount pad of a chainsaw body and be dimensioned to be received in a slot of a guide bar when the guide bar is mounted to the chainsaw body. The side cover may be selectively mountable to the chainsaw body in a closed configuration in which the mounting stud is disposed between the bar mount pad and the side cover. The retention member may be coupled to the chainsaw body and positioned to retain the guide bar against the bar mount pad when the mounting stud is received in the slot of the guide bar. Other embodiments may be disclosed and/or claimed.

### TECHNICAL FIELD

The present disclosure relates generally to the field of power tools, and more particularly, to chainsaws.

### BACKGROUND

In conventional chainsaw designs, a user must adjust a guide bar and saw chain by removing a side cover from the chainsaw, adjusting the saw chain around the periphery of the guide bar and around a sprocket of the chainsaw body, then re-mounting the side cover. However, since it is the side cover that typically exerts a force against the guide bar to “sandwich” the guide bar between the side cover and the bar mount pad, removing the side cover results in both the guide bar and saw chain “falling off” the chainsaw body. A user must thus carefully balance the guide bar on the bar mount pad (e.g., with a hand, foot, or other implement) while attempting to position the saw chain in a manner that won't knock the guide bar out of place or allow the guide bar to fall to the ground.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is an exploded view of a chainsaw with a guide bar retention system, in accordance with various embodiments.

FIGS. 2-4 depict a spring clip, which may serve as a retention member of the guide bar retention system of FIG. 1, in accordance with various embodiments.

FIG. 5 is a perspective view of a portion of the chainsaw body of FIG. 1, in accordance with various embodiments.

FIG. 6 is a perspective view of the portion of the chainsaw body depicted in FIG. 5, subsequent to coupling a spring clip to a projection, in accordance with various embodiments.

FIG. 7 is a perspective view of the portion of the chainsaw body depicted in FIG. 6, subsequent to mounting a guide bar against a bar mount pad, in accordance with various embodiments.

FIG. 8 is an exploded view of a chainsaw with another embodiment of a guide bar retention system, in accordance with various embodiments.

FIG. 9 is a perspective view of a portion of the chainsaw body of FIG. 8, in accordance with various embodiments.

FIG. 10 is a perspective view of the portion of the chainsaw body depicted in FIG. 9 subsequent to mounting a guide bar against the bar mount pad and securing a retention member, in accordance with various embodiments.

FIG. 11 is an exploded view of a chainsaw with another embodiment of a guide bar retention system, in accordance with various embodiments.

FIG. 12 depicts a spring clip, which may serve as a retention member of the guide bar retention system of FIG. 11, in accordance with various embodiments.

FIG. 13 is a perspective view of a portion of the chainsaw body of FIG. 11, in accordance with various embodiments.

FIG. 14 is a perspective view of the portion of the chainsaw body depicted in FIG. 13 subsequent to mounting a guide bar against the bar mount pad and securing a retention member, in accordance with various embodiments.

FIG. 15 is a flow diagram of a process for manufacturing a bar mount portion of a chainsaw body.

### DETAILED DESCRIPTION

Disclosed herein are systems and methods for securing a guide bar to a chainsaw body when the side cover is removed so as to allow a user to position a saw chain or perform any other desired set up, cleaning or maintenance operations without having the guide bar fall off the chainsaw body. In some embodiments, a chainsaw may include a mounting stud, a side cover and the retention member. The mounting stud may extend away from a bar mount pad of a chainsaw body and be dimensioned to be received in a slot of a guide bar when the guide bar is mounted to the chainsaw body. The side cover may be selectively mountable to the chainsaw body in a closed configuration in which the mounting stud is disposed between the bar mount pad and the side cover. The retention member may be coupled to the chainsaw body and positioned to retain the guide bar against the bar mount pad when the mounting stud is received in the slot of the guide bar. In particular, the retention member may retain the guide bar against the bar mount pad when the side cover is not mounted to the chainsaw body in the closed configuration (e.g., before the side cover is mounted or after the side cover is removed).

In some embodiments, the guide bar retention systems disclosed herein may hold a guide bar in position flat against a bar mount pad of a chainsaw body. The chainsaw body may utilize a single mounting stud design, or another mounting stud design. In some embodiments, the guide bar retention system may include two or more spring clips coupled to the bar mount pad in alignment with the mounting stud. The inside of a slot in the guide bar may “snap” over the wide portion of the clips, causing the clips to slightly compress until the guide bar is disposed against the bar mount pad. In some embodiments, the guide bar retention system may include two or more pins extending through holes in projections that themselves extend through the slot in the guide bar. The pins may be in contact with a surface of the guide bar, and may sandwich the guide bar between the pins and the bar mount pad. Other embodiments are contemplated. The guide bar retention systems disclosed herein may hold the end of the guide bar in place, allowing the user of the chainsaw to lay a chainsaw body on its side (e.g., flywheel down), or in any other desired orientation, and easily mount a saw chain over the guide bar and around the drive sprocket without the guide bar falling off of the chainsaw body. This functionality may be particularly valuable to users undertaking a new saw chain installation or the reinstallation of a saw chain that has been thrown off of the guide bar.

In the following detailed description, reference is made to the accompanying drawings that form a part hereof wherein like numerals designate like parts throughout, and in which are shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the disclosed embodiments. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description uses the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

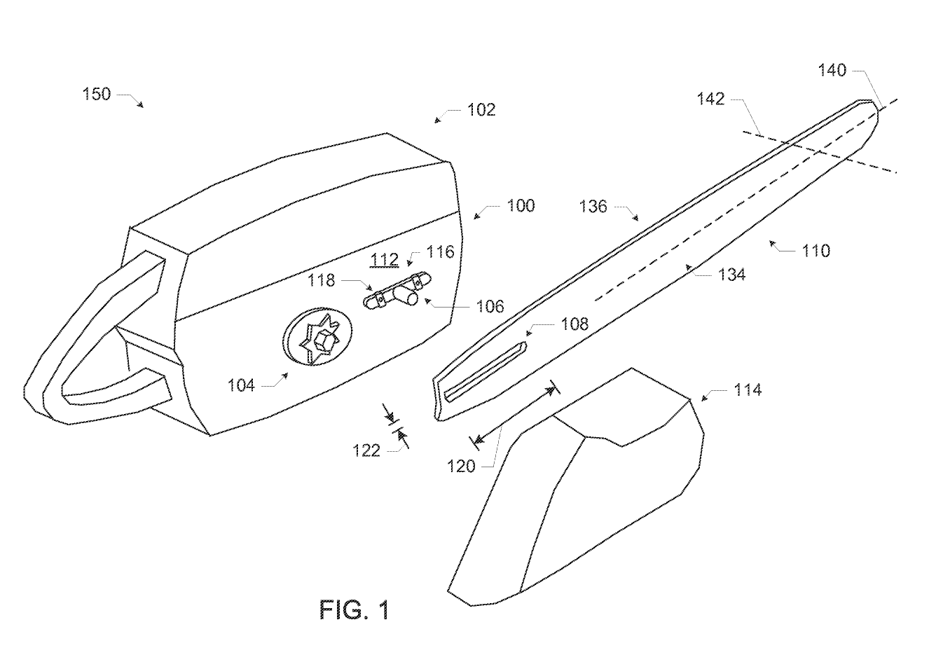

FIG. 1 is an exploded view of the chainsaw 150 with a guide bar retention system 100, in accordance with various embodiments. The chainsaw 150 may include a chainsaw body 102 having a bar mount pad 112 and a sprocket 104. In some embodiments, the bar mount pad 112 may be integral with the chainsaw body 102 (e.g., flush with other features of the chainsaw body 102, as shown, or projecting from the chainsaw body 102 but formed integrally with the chainsaw body 102). In some embodiments, the bar mount pad 112 may be formed separately and mounted to the chainsaw body 102 (e.g., via one or more screws, glue, snaps, or any other mounting mechanism). A mounting stud 106 may extend from the bar mount pad 112, and may be dimensioned to extend through a slot 108 in a guide bar 110 when the chainsaw 150 is assembled.

In some embodiments, the chainsaw 150 may include a single mounting stud 106 extending from chainsaw 150 (e.g., as shown in FIG. 1). In other embodiments, the chainsaw 150 may include two or more mounting studs 106, each dimensioned to extend through the slot 108 (e.g., at various points along the longitudinal axis 140 of the guide bar 110). The teachings of the present disclosure may be particularly advantageous when applied to a chainsaw 150 having a single mounting stud 106 because the single mounting stud 106 may act as an axis around which the guide bar 110 may rotate when the mounting stud 106 is received in the slot 108. While it is difficult enough to prevent the guide bar 110 from rotating around the longitudinal axis 140 during set-up and other operations (a challenge experienced by users of chainsaws with two or more mounting studs), the additional rotational freedom around the transverse axis 142 experienced by users of single mounting stud chainsaws makes it even more difficult for a user to control the guide bar 110. Embodiments in which a single mounting stud 106 is included in the chainsaw body 102 are principally discussed herein, but the teachings of the present disclosure also apply to chainsaws with multiple mounting studs.

The guide bar 110 may have a first face 134 and a second face 136 such that, when the mounting stud 106 is received in the slot 108, the second face 136 is disposed between the first face 134 and the bar mount pad 112. The slot 108 may have a longitudinal length 120 and a lateral width 122. When the mounting stud 106 is received in the slot 108, a saw chain (not shown) may be disposed around the periphery of the guide bar 110 and around the sprocket 104 so that the saw chain may be driven around the guide bar 110 by rotation of the sprocket 104, in accordance with known configurations. The chainsaw 150 may also include a selectively mountable side cover 114. When the guide bar 110 and the saw chain (not shown) are positioned on the chainsaw body 102, the side cover 114 may be secured to the chainsaw body 102 in a closed configuration to cover the sprocket 104 and the slot 108.

The guide bar retention system 100 may be coupled to the chainsaw body 102 and may be positioned to retain the guide bar 110 against the bar mount pad 112. The guide bar retention system 100 may retain the guide bar 110 against the bar mount pad 112 when the side cover 114 is not mounted to the chainsaw body 102 (e.g., before the side cover 114 is coupled to the chainsaw body 102). In some embodiments, when the mounting stud 106 is received in the slot 108 of the guide bar 110 and the guide bar 110 is positioned against the bar mount pad 112, the guide bar retention system 100 may apply a force to the first face 134 of the guide bar 110 toward the bar mount pad 112. In particular, in some embodiments, the guide bar retention system 100 may include one or more components that extend from the bar mount pad 112 beyond the first face 134 of the guide bar 110, and apply a force to the first face 134 to retain the guide bar 110 against the bar mount pad 112. This force may be a mechanical contact force. In some embodiments, when the mounting stud 106 is received in the slot 108 of the guide bar 110 and the guide bar 110 is positioned against the bar mount pad 112, one or more components of the guide bar retention system 100 may apply a force to the inner perimeter of the slot 108 of the guide bar.

A number of embodiments of guide bar retention systems 100 are disclosed herein. In FIG. 1, a guide bar retention system 100 is illustrated in which a retention member 116 is mounted to a projection 118 extending from the bar mount pad 112. The projection 118 may be dimensioned to be received in the slot 108 when the guide bar 110 is disposed against the bar mount pad 112. A retention member 116 may be coupled to the projection 118. The retention member 116 may also be dimensioned to be received in the slot 108 when the guide bar 110 is disposed against the bar mount pad 112. In some embodiments, the retention member 116 may be configured such that when the projection 118 is received in the slot 108, the retention member 116 may exert a force on the guide bar 110 that resists rotation of the guide bar 110 around the longitudinal axis 140 of the guide bar 110 or around the transverse axis 142 of the guide bar 110. In the embodiment of FIG. 1, when the mounting stud 106 is received in the slot 108 of the guide bar 110 and the guide bar 110 is positioned against the bar mount pad 112, the guide bar retention system 100 may apply a force to the first face 134 of the guide bar 110 toward the bar mount pad 112. In particular, in the embodiment of FIG. 1, the guide bar retention system 100 may include one or more components that extend from the bar mount pad 112 beyond the first face 134 of the guide bar 110, and apply a force to the first face 134 to retain the guide bar 110 against the bar mount pad 112. This force may be a mechanical contact force. Also, in the embodiment of FIG. 1, when the mounting stud 106 is received in the slot 108 of the guide bar 110 and the guide bar 110 is positioned against the bar mount pad 112, one or more components of the guide bar retention system 100 may apply a force to the inner perimeter of the slot 108 of the guide bar.

In some embodiments, as shown in FIG. 1, the guide bar retention system 100 may include two or more retention members 116. In particular, the retention members 116 may be arranged so as to be received in the slot 108 at various points along the longitudinal axis 140. In some embodiments, the retention member 116 may not be coupled to the projection 118, but may instead be coupled to a substantially planar face of the bar mount pad 112.

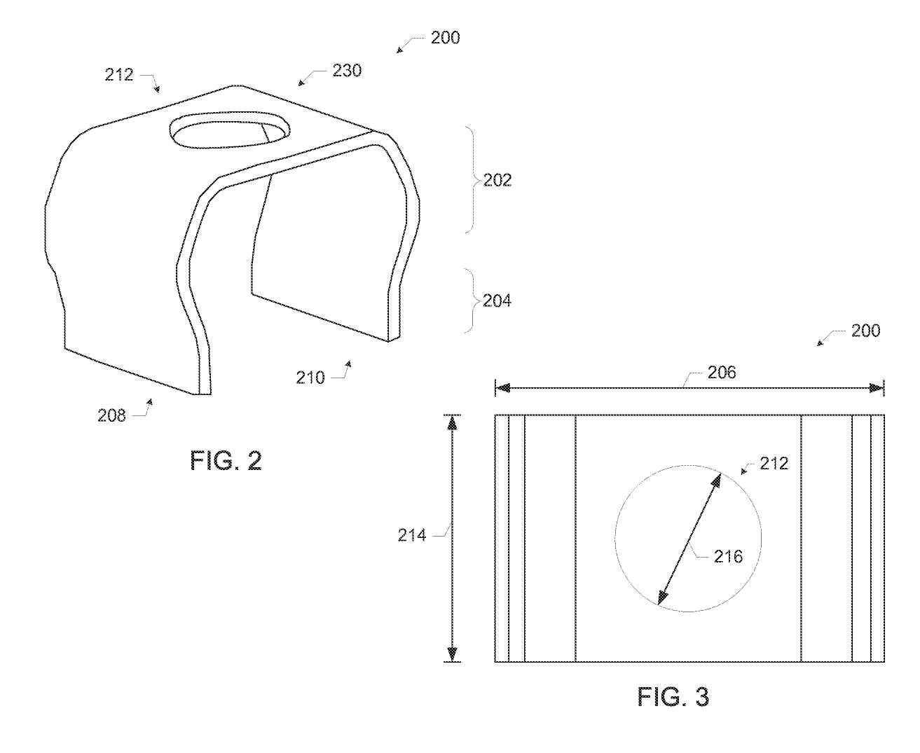

In some embodiments, the retention member 116 may take the form of a spring clip. FIGS. 2-4 depict a spring clip 200, which may serve as the retention member 116 of the guide bar retention system 100, in accordance with various embodiments. FIG. 2 is a perspective view of the spring clip 200, in accordance with various embodiments. As shown, the spring clip 200 includes two legs 208 and 210 joined by a top portion 230. Bends or curves in the legs 208 and 210 define a wide portion 202 of the spring clip 200 and a narrow portion 204 of the spring clip 200. A hole 212 may be disposed in the top portion 230. The spring clip 200 may be formed from any material that allows for suitable elastic deformation. For example, in various embodiments, the spring clip 200 may be formed from rubber, spring steel, plastic, or any combination of suitable materials.

FIG. 3 is a top view of the spring clip 200, in accordance with various embodiments. The spring clip 200 may have a width 206 of the wide portion 202. In some embodiments, when the spring clip 200 is not under tension squeezing the legs 208 and 210 together, the width 206 of the wide portion 202 may be larger than the lateral width 122 of the slot 108 of the guide bar 110. For example, in some embodiments, the lateral width 122 of the slot 108 may be approximately 6 millimeters, and the width 206 of the wide portion 202 may be approximately equal to or greater than approximately 6 millimeters. For example, the width 206 of the wide portion 202 may be in the range of approximately 7.5 millimeters to approximately 10 millimeters. When forces applied to the spring clip 200 squeeze the legs 208 and 210 together, the width 206 of the wide portion 202 may temporarily decrease so as to allow the wide portion 202 of the spring clip 200 to fit through the slot 108 of the guide bar 110. The spring clip 200 may have a length 214. In some embodiments, the length 214 may be in the range of approximately 4 millimeters to approximately 10 millimeters. For example, in some embodiments, the length 214 may be approximately 5.5 millimeters. The hole 212 in the top portion 230 may have a diameter 216. In some embodiments, the diameter 216 may be in the range of approximately 2 millimeters to approximately 5 millimeters. For example, in some embodiments, the diameter 216 may be approximately 3.3 millimeters.

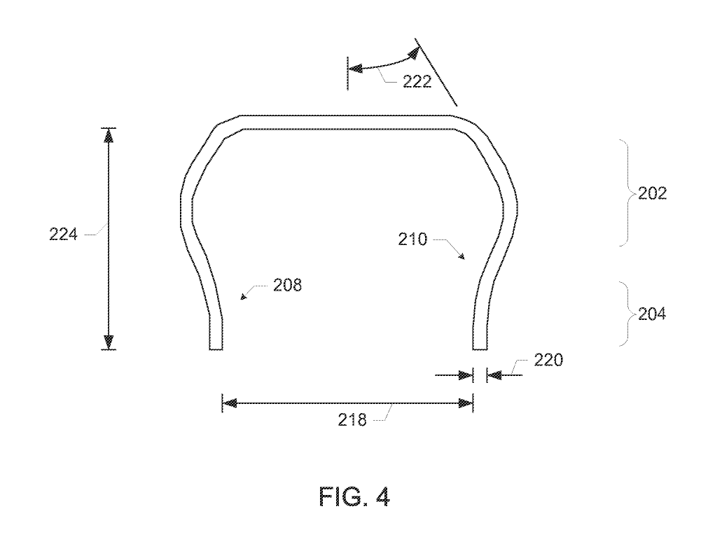

FIG. 4 is a side view of the spring clip 200, in accordance with various embodiments. The spring clip 200 may have a height 224. In some embodiments, the height 224 may be in the range of approximately 5 millimeters to approximately 10 millimeters. For example, in some embodiments, the height 224 may be approximately 6 millimeters. The spring clip 200 may have a thickness 220. In some embodiments, the thickness 220 may be in the range of approximately 0.2 millimeters to approximately 0.6 millimeters. For example, in some embodiments, the thickness 220 may be in the range of approximately 0.3 millimeters to approximately 0.4 millimeters. The spring clip 200 may have an extension angle 222 of the legs 208 and 210 at the wide portion 202. In some embodiments, the extension angle 222 may be in the range of approximately 20 degrees to approximately 50 degrees. For example, in some embodiments, the extension angle 222 may be approximately 30 degrees. The spring clip 200 may have a width 218 between the legs 208 and 210 in the narrow portion 204. In some embodiments, the width 218 may be less than the lateral width 122 of the slot 108 in the guide bar 110. In some embodiments, the width 218 may be in the range of approximately 4 millimeters to approximately 9 millimeters. For example, in some embodiments, the width 218 may be approximately 6.5 millimeters.

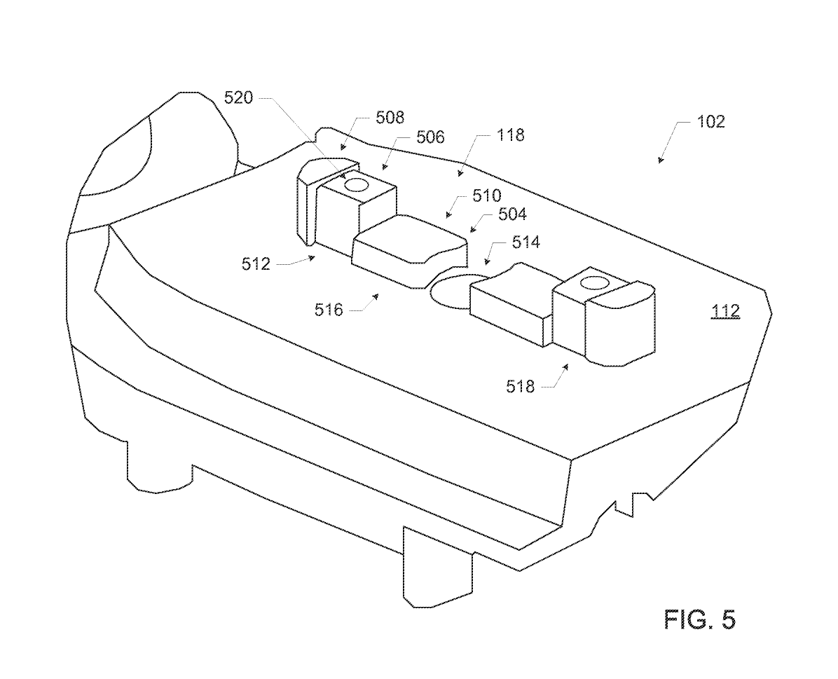

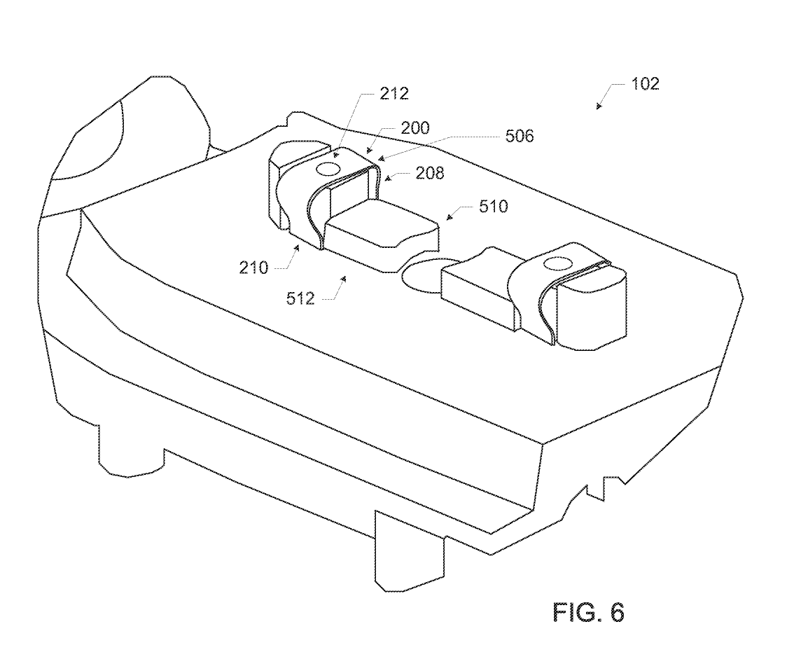

FIG. 5 is a perspective view of a portion of the chainsaw body 102 of FIG. 1, in accordance with various embodiments. In particular, FIG. 5 depicts an embodiment of the projection 118 extending from the bar mount pad 112. The embodiment of the projection 118 depicted in FIG. 5 has a first side 510 and a second side 512, and includes a first segment 516 of the projection 118 and a second segment 518 of the projection 118. The first segment 516 and the second segment 518 may be separated by a hole 514 in which the mounting stud 106 may be disposed (not shown). For example, the hole 514 may be a threaded hole, and a threaded mounting stud 106 may be screwed into the hole 514. In some embodiments (e.g., as shown in FIG. 5), the first segment 516 and the second segment 518 may be configured in mirror image arrangements around the hole 514. For this reason, only the arrangement of the first segment 516 is discussed below with reference to FIG. 5. In some embodiments, the projection 118 may include multiple portions, each having a different height with respect to the bar mount pad 112. For example, the first segment 516 of the projection 118 of FIG. 5 may include a first portion 504, a second portion 506, and a third portion 508. As shown in FIG. 5, the first portion 504 may have a smaller height than the second portion 506, and the second portion 506 may have a smaller height than the third portion 508. The first portion 504, the second portion 506, and the third portion 508 may be dimensioned to be received in the slot 108 of the guide bar 110 when the guide bar 110 is mounted against the bar mount pad 112. In some embodiments, the first portion 504 and/or the third portion 508 may be omitted. The second portion 506 may include a threaded hole 520; as discussed below with reference to FIG. 6, the threaded hole 520 may align with the hole 212 of the spring clip 200 when the spring clip 200 is mounted to the second portion 506.

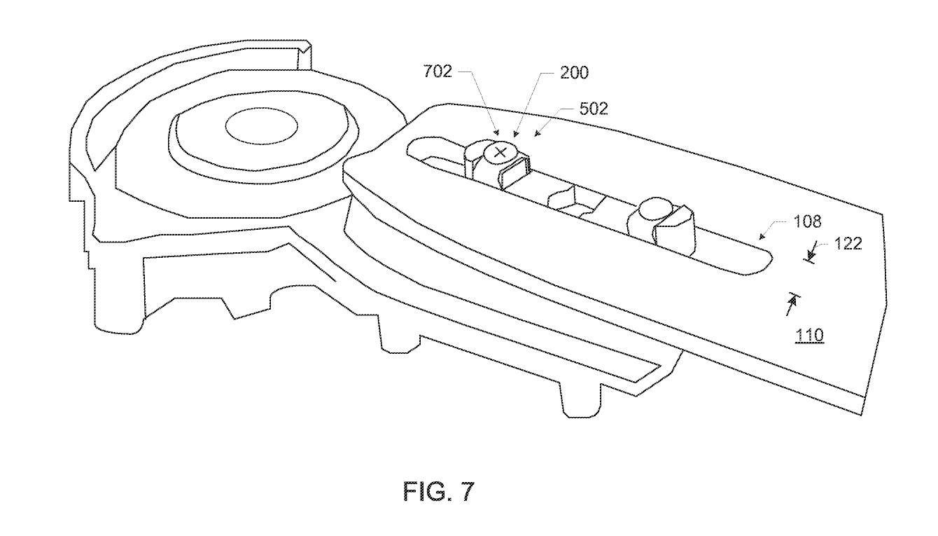

FIG. 6 is a perspective view of the portion of the chainsaw body 102 depicted in FIG. 5, subsequent to coupling a spring clip 200 to the projection 118, in accordance with various embodiments. As shown in FIG. 6, the spring clip 200 may be coupled to the second portion 506 of the projection 118. In particular, the leg 208 may be disposed proximate to the first side 510 of the projection 118 and the leg 210 may be disposed proximate to the second side 512 of the projection 118. The hole 212 of the spring clip 200 may be axially aligned with the threaded hole 520. In some embodiments, a bolt or screw (not shown) may be provided to extend through the hole 212 of the spring clip 200 and into the threaded hole 520 to couple the spring clip 200 to the chainsaw body 102. Such an embodiment is discussed in additional detail below with reference to FIG. 7. The spring clip 200 may be removably coupled to the chainsaw body 102 (e.g., by removing the screw through the hole 212 and sliding the spring clip 200 away from the second portion 506 of the projection 118). When the spring clip 200 is mounted to the projection 118, the narrow portion 204 of the spring clip 200 may be disposed between the wide portion 202 of the spring clip 200 and the bar mount pad 112 along the direction in which the mounting stud 106 (FIG. 1) extends away from the bar mount pad 112.

FIG. 7 is a perspective view of the portion of the chainsaw body 102 depicted in FIG. 6, subsequent to mounting the guide bar 110 against the bar mount pad 112, in accordance with various embodiments. As shown in FIG. 7, a bolt, screw, or other securing device 702 may be provided to couple the spring clip 200 to the projection 118. When the guide bar 110 is mounted against the bar mount pad 112, the wide portion 202 of the spring clip 200 may be compressed such that the width 206 is less than or equal to the lateral width 122 of the slot 108. This compression may occur by a user pressing the guide bar 110 against the spring clip 200 until the legs 208 and 210 deform so as to allow the slot 108 to pass over the wide portion 202 until the guide bar 110 is proximate to the narrow portion 204 of the spring clip 200. Once the guide bar 110 is proximate to the narrow portion 204 of the spring clip 200, the forces applied to the legs 208 and 210 may be reduced, the legs 208 and 210 may separate, and the guide bar 110 may be “trapped” between the wide portion 202 of the spring clip 200 and the bar mount pad 112. The guide bar 110 may thus be retained against the bar mount pad 112 so that a user may position a saw chain around the guide bar 110 and perform other desired set up operations without the guide bar 110 “falling off” the chainsaw body 102. Once set up is complete, the user may attach the side cover 114 in the closed configuration.

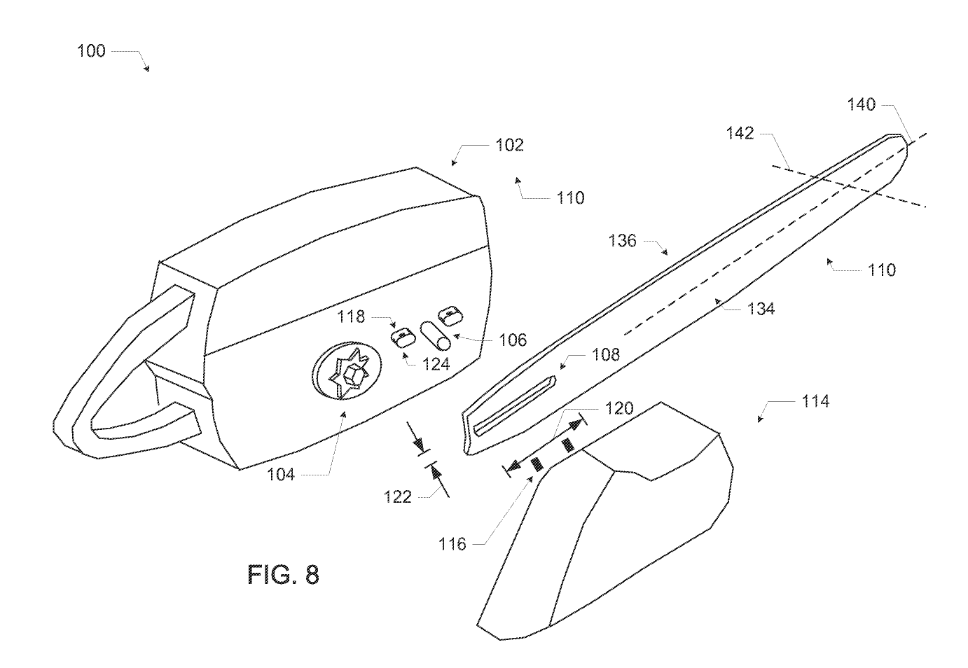

FIG. 8 is an exploded view of the chainsaw 150 with another embodiment of the guide bar retention system 100, in accordance with various embodiments. As discussed above with reference to FIG. 1, the chainsaw 150 may include a chainsaw body 102 having a bar mount pad 112 and a sprocket 104. A mounting stud 106 may extend from the bar mount pad 112, and may be dimensioned to extend through a slot 108 in a guide bar 110 when the chainsaw 150 is assembled. The guide bar 110 may have a first face 134 and a second face 136 such that, when the mounting stud 106 is received in the slot 108, the second face 136 is disposed between the first face 134 and the bar mount pad 112. The slot 108 may have a longitudinal length 120 and a lateral width 122. The chainsaw 150 may also include a selectively mountable side cover 114. Any of the embodiments of the components of the chainsaw 150 discussed above with reference to FIG. 1 may apply to embodiments of the chainsaw 150 discussed with reference to FIG. 8.

As discussed above with reference to the guide bar retention system 100 of FIG. 1, the guide bar retention system 100 of FIG. 8 may be coupled to the chainsaw body 102 and may be positioned to retain the guide bar 110 against the bar mount pad 112. The guide bar retention system 100 may retain the guide bar 110 against the bar mount pad 112 when the side cover 114 is not mounted to the chainsaw body 102 (e.g., before the side cover 114 is coupled to the chainsaw body 102).

As shown, the guide bar retention system 100 of FIG. 8 may include a projection 118 extending from the bar mount pad 112. The projection 118 may be dimensioned to be received in the slot 108 when the guide bar 110 is disposed against the bar mount pad 112. The projection 118 may include a hole 124. The hole 124 may be oriented perpendicular to the direction in which the projection 118 extends away from the bar mount pad 112 (e.g., as shown). The guide bar retention system 100 may also include a retention member 116, which may be dimensioned to be received in the hole 124 after the guide bar 110 is disposed against the bar mount pad 112 and the projection 118 extends through the slot 108. When the retention member 116 is received in the hole 124, the retention member 116 may “trap” the guide bar 110 between the retention member 116 and the bar mount pad 112. In particular, the retention member 116 may be configured such that when the projection 118 is received in the slot 108, the retention member 116 may exert a force on the guide bar 110 that resists rotation of the guide bar 110 around the longitudinal axis 140 of the guide bar 110 or around the transverse axis 142 of the guide bar 110. In the embodiment of FIG. 8, when the mounting stud 106 is received in the slot 108 of the guide bar 110 and the guide bar 110 is positioned against the bar mount pad 112, the guide bar retention system 100 may apply a force to the first face 134 of the guide bar 110 toward the bar mount pad 112. In particular, in the embodiment of FIG. 8, the guide bar retention system 100 may include one or more components that extend from the bar mount pad 112 beyond the first face 134 of the guide bar 110, and apply a force to the first face 134 to retain the guide bar 110 against the bar mount pad 112. This force may be a mechanical contact force. In some embodiments, as shown in FIG. 8, the guide bar retention system 100 may include two or more projections 118 and two or more corresponding retention members 116. In particular, the projections 118 may be arranged so as to be received in the slot 108 at various points along the longitudinal axis 140.

In some embodiments, the retention member 116 may take the form of a cotter pin or other member (generally referred to herein as a “pin”) that can be inserted at least partially through the hole 124 without “falling out” of the hole 124 when the user is assembling the chainsaw 150 (e.g, mounting the saw chain). For example, the hole 124 and the retention member 116 may be threaded so that the retention member 116 may be coupled in threaded engagement with the hole 124. Any other suitable configuration of the retention member 116 may be used. In some embodiments, the retention member 116 may have a flat or curved surface dimensioned to contact a surface of the guide bar 110 when the guide bar 110 is positioned between the bar mount pad 112 and the retention member 116.

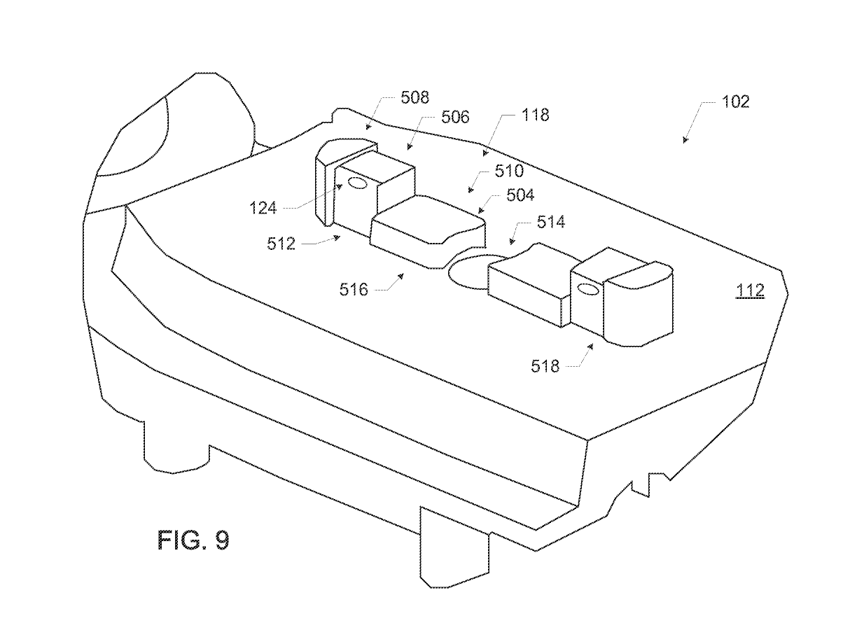

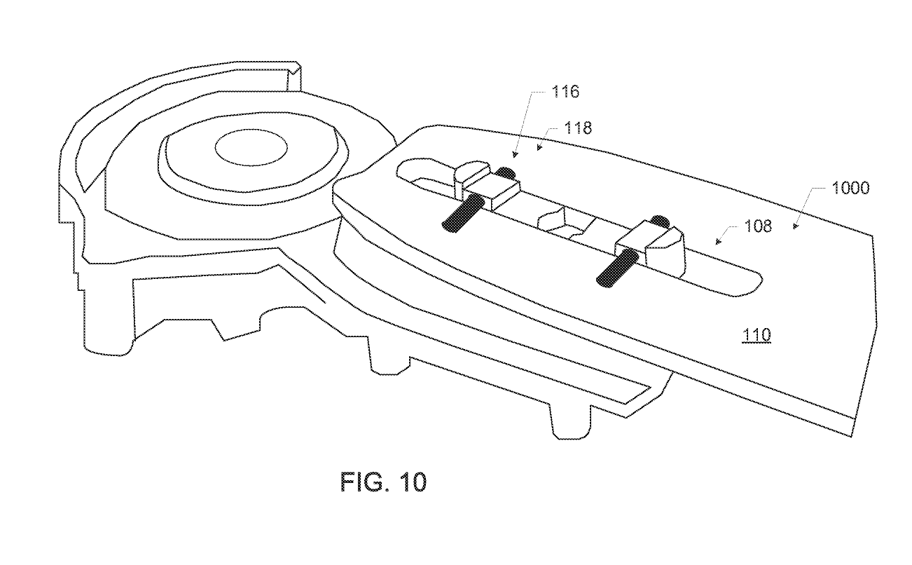

FIG. 9 is a perspective view of a portion of the chainsaw body 102 of FIG. 8, in accordance with various embodiments. In particular, FIG. 9 depicts an embodiment of the projection 118 extending from the bar mount pad 112. As discussed above with reference to FIG. 1, the embodiment of the projection 118 depicted in FIG. 9 has a first side 510 and a second side 512, and includes a first segment 516 of the projection 118 and a second segment 518 of the projection 118. The first segment 516 and the second segment 518 may be separated by a hole 514 in which the mounting stud 106 may be disposed (not shown). For example, the hole 514 may be a threaded hole, and a threaded mounting stud 106 may be screwed into the hole 514. In some embodiments (e.g., as shown in FIG. 9), the first segment 516 and the second segment 518 may be configured in mirror image arrangements around the hole 514. For this reason, only the arrangement of the first segment 516 is discussed below.

In some embodiments, the projection 118 may include multiple portions, each having a different height with respect to the bar mount pad 112. For example, the first segment 516 of the projection 118 of FIG. 9 may include a first portion 504, a second portion 506, and a third portion 508. As shown in FIG. 9, the first portion 504 may have a smaller height than the second portion 506, and the second portion 506 may have a smaller height than the third portion 508. The first portion 504, the second portion 506, and the third portion 508 may be dimensioned to be received in the slot 108 of the guide bar 110 when the guide bar 110 is mounted against the bar mount pad 112. In some embodiments, the first portion 504 and/or the third portion 508 may be omitted. The second portion 506 may include the hole 124, which, as discussed above with reference to FIG. 8, may be dimensioned to receive the retention member 116.

FIG. 10 is a perspective view of the portion of the chainsaw body 102 depicted in FIG. 9 subsequent to mounting the guide bar 110 against the bar mount pad 112 and securing the retention member 116, in accordance with various embodiments. As shown in FIG. 10, the retention member 116 may be disposed in the hole 124 to retain the guide bar 110 against the bar mount pad 112. In some embodiments, the retention member 116 may contact the face 1000 of the guide bar 110 when the guide bar 110 is flush against the bar mount pad 112. In other embodiments, the retention member 116 may be spaced away from the face 1000 of the guide bar 110 when the guide bar 110 is flush against the bar mount pad 112. In some such embodiments, the retention member 116 may contact the guide bar 110 if the guide bar 110 begins to “fall off” the bar mount pad 112. In particular, when the retention member 116 is disposed in the hole 124, the guide bar 110 may be retained against the bar mount pad 112 so that a user may position a saw chain around the guide bar 110 and perform other desired set up operations without the guide bar 110 “falling off” the chainsaw body 102. Once setup is complete, the user may attach the side cover 114 in the closed configuration.

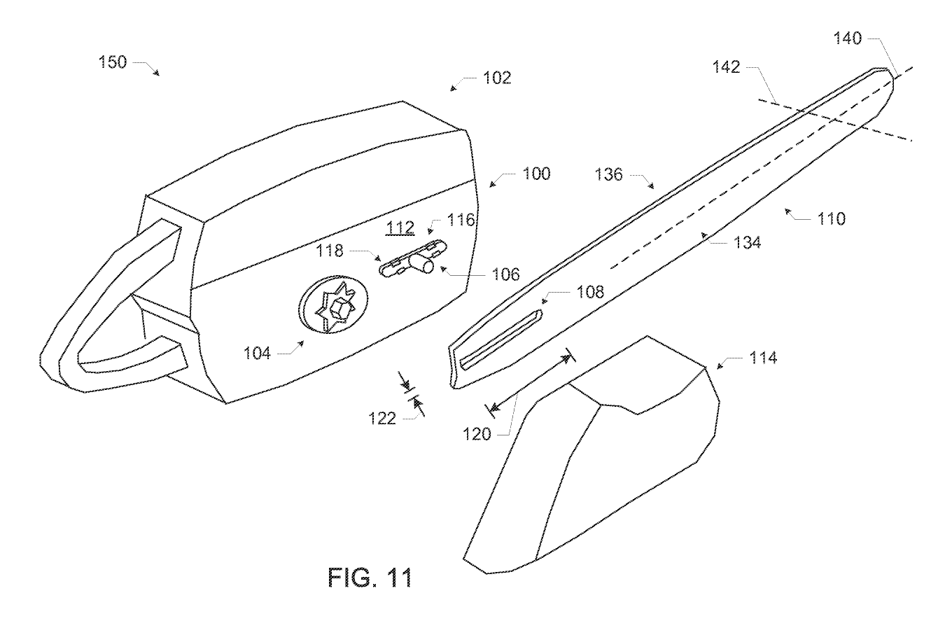

FIG. 11 is an exploded view of the chainsaw 150 with another embodiment of the guide bar retention system 100, in accordance with various embodiments. As discussed above with reference to FIGS. 1 and 8, the chainsaw 150 may include a chainsaw body 102 having a bar mount pad 112 and a sprocket 104. A mounting stud 106 may extend from the bar mount pad 112, and may be dimensioned to extend through a slot 108 in a guide bar 110 when the chainsaw 150 is assembled. The guide bar 110 may have a first face 134 and a second face 136 such that, when the mounting stud 106 is received in the slot 108, the second face 136 is disposed between the first face 134 and the bar mount pad 112. The slot 108 may have a longitudinal length 120 and a lateral width 122. The chainsaw 150 may also include a selectively mountable side cover 114. Any of the embodiments of the components of the chainsaw 150 discussed above with reference to FIGS. 1 and 8 may apply to embodiments of the chainsaw 150 discussed with reference to FIG. 11.

As discussed above with reference to the guide bar retention system 100 of FIGS. 1 and 8, the guide bar retention system 100 of FIG. 11 may be coupled to the chainsaw body 102 and may be positioned to retain the guide bar 110 against the bar mount pad 112. The guide bar retention system 100 may retain the guide bar 110 against the bar mount pad 112 when the side cover 114 is not mounted to the chainsaw body 102 (e.g., before the side cover 114 is coupled to the chainsaw body 102).

In FIG. 11, a guide bar retention system 100 is illustrated in which a retention member 116 is mounted to a projection 118 extending from the bar mount pad 112. The projection 118 may be dimensioned to be received in the slot 108 when the guide bar 110 is disposed against the bar mount pad 112. A retention member 116 may be coupled to the projection 118. The retention member 116 may also be dimensioned to be received in the slot 108 when the guide bar 110 is disposed against the bar mount pad 112. In some embodiments, the retention member 116 may be configured such that when the projection 118 is received in the slot 108, the retention member 116 may exert a force on the guide bar 110 that resists rotation of the guide bar 110 around the longitudinal axis 140 of the guide bar 110 or around the transverse axis 142 of the guide bar 110. In the embodiment of FIG. 11, when the mounting stud 106 is received in the slot 108 of the guide bar 110 and the guide bar 110 is positioned against the bar mount pad 112, the guide bar retention system 100 may apply a force to the first face 134 of the guide bar 110 toward the bar mount pad 112. In particular, in the embodiment of FIG. 11, the guide bar retention system 100 may include one or more components that extend from the bar mount pad 112 beyond the first face 134 of the guide bar 110, and apply a force to the first face 134 to retain the guide bar 110 against the bar mount pad 112. This force may be a mechanical contact force. Also, in the embodiment of FIG. 11, when the mounting stud 106 is received in the slot 108 of the guide bar 110 and the guide bar 110 is positioned against the bar mount pad 112, one or more components of the guide bar retention system 100 may apply a force to the inner perimeter of the slot 108 of the guide bar.

In some embodiments, as shown in FIG. 1, the guide bar retention system 100 may include two or more retention members 116. In particular, the retention members 116 may be arranged so as to be received in the slot 108 at various points along the longitudinal axis 140. In some embodiments, the retention member 116 may not be coupled to the projection 118, but may instead be coupled to a substantially planar face of the bar mount pad 112.

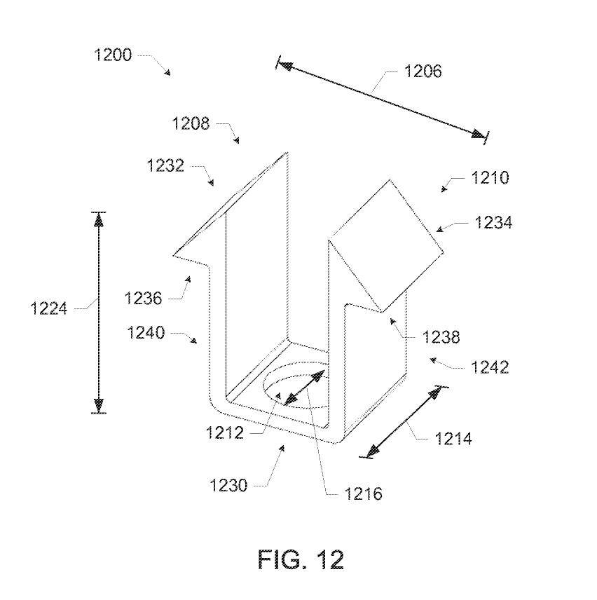

In some embodiments, the retention member 116 may take the form of a spring clip. FIG. 12 depicts a spring clip 1200, which may serve as the retention member 116 of the guide bar retention system 100, in accordance with various embodiments. FIG. 12 is a perspective view of the spring clip 200, in accordance with various embodiments. As shown, the spring clip 1200 includes two legs 1208 and 1210 joined by a bottom portion 1230. Each of the legs 1208 and 1210 includes a latch (the latches 1232 and 1234, respectively). The latches 1232 and 1234 are defined by respective lips 1236 and 1238 extending away from the faces 1240 and 1242, respectively, of the legs 1208 and 1210. In some embodiments, the latches 1232 and 1234 may have a substantially triangular cross-section (as shown). In some embodiments, the latches 1232 and 1234 may have a non-triangular cross section (e.g., a curved or rectangular cross-section). The latches 1232 and 1234 define a wide portion 1202 of the spring clip 1200 and a narrow portion 1204 of the spring clip 1200. A hole 1212 may be disposed in the bottom portion 1230. The spring clip 1200 may be formed from any material that allows for suitable elastic deformation. For example, in various embodiments, the spring clip 1200 may be formed from rubber, spring steel, plastic, or any combination of suitable materials.

The spring clip 1200 may have a width 1206 of the wide portion 1202. In some embodiments, when the spring clip 1200 is not under tension squeezing the legs 1208 and 1210 together, the width 1206 of the wide portion 1202 may be larger than the lateral width 122 of the slot 108 of the guide bar 110. For example, in some embodiments, the lateral width 122 of the slot 108 may be approximately 6 millimeters, and the width 1206 of the wide portion 1202 may be approximately equal to or greater than approximately 6 millimeters. For example, the width 1206 of the wide portion 1202 may be in the range of approximately 7.5 millimeters to approximately 10 millimeters. When forces applied to the spring clip 1200 squeeze the legs 1208 and 1210 together (e.g., when the slot 108 exerts forces on the latches 1232 and 1234 as the latches 1232 and 1234 transition from one face of the guide bar 110 to the other), the width 1206 of the wide portion 1202 may temporarily decrease so as to allow the wide portion 1202 of the spring clip 1200 to fit through the slot 108 of the guide bar 110. The spring clip 1200 may have a length 214. In some embodiments, the length 214 may be in the range of approximately 4 millimeters to approximately 10 millimeters. The hole 1212 in the bottom portion 1230 may have a diameter 1216. In some embodiments, the diameter 1216 may be in the range of approximately 2 millimeters to approximately 5 millimeters.

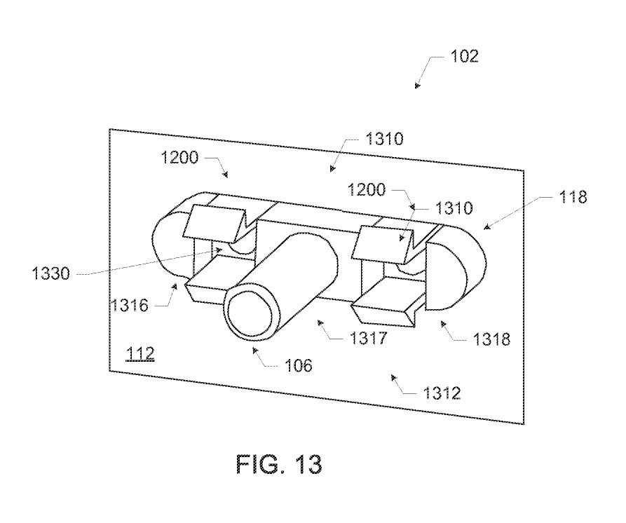

The spring clip 1200 may have a height 1224. In some embodiments, the height 224 may be in the range of approximately 5 millimeters to approximately 10 millimeters. FIG. 13 is a perspective view of a portion of the chainsaw body 102 of FIG. 11, in accordance with various embodiments. In particular, FIG. 13 depicts an embodiment of the projection 118 extending from the bar mount pad 112. The embodiment of the projection 118 depicted in FIG. 13 has a first side 1310 and a second side 1312, and includes a first segment 1316 of the projection 118, a second segment 1318 of the projection 118, and a third segment 1317 of the projection 118. The mounting stud 106 may extend from the third segment 1317. In some embodiments, the third segment 1317 may include a hole in which the mounting stud 106 may be selectively disposed (e.g., as discussed above with reference to the hole 514 of FIG. 5). In some embodiments (e.g., as shown in FIG. 13), the first segment 1316 and the second segment 1318 may be configured in mirror image arrangements around the third segment 1317. For this reason, only the arrangement of the components proximate to the first segment 1316 is discussed below with reference to FIG. 13.

The spring clip 1200 may be disposed between the first segment 1316 and the third segment 1317. In particular, the leg 1208 may be disposed proximate to the first side 1310 of the projection 118 and the leg 1210 may be disposed proximate to the second side 1312 of the projection 118. The bar mount pad 112 may include a hole (not shown) which, when the spring clip 1200 is disposed between the first segment 1316 and the third segment 1317 as shown, the hole in the bar mount pad 112 (e.g., a threaded hole) may align with the hole 1212 in the spring clip 1200. In some embodiments, a bolt, screw, or other securing device 1330 may be provided to extend through the hole 1212 of the spring clip 1200 and into the hole in the bar mount pad 112 to couple the spring clip 1200 to the chainsaw body 102 (e.g., in a similar manner as discussed above with reference to FIG. 7). The spring clip 1200 may be removably coupled to the chainsaw body 102 (e.g., by removing the securing device 1330 through the hole 1212. When the spring clip 1200 is mounted to the projection 118, the narrow portion 1204 of the spring clip 1200 may be disposed between the wide portion 1202 of the spring clip 1200 and the bar mount pad 112 along the direction in which the mounting stud 106 extends away from the bar mount pad 112.

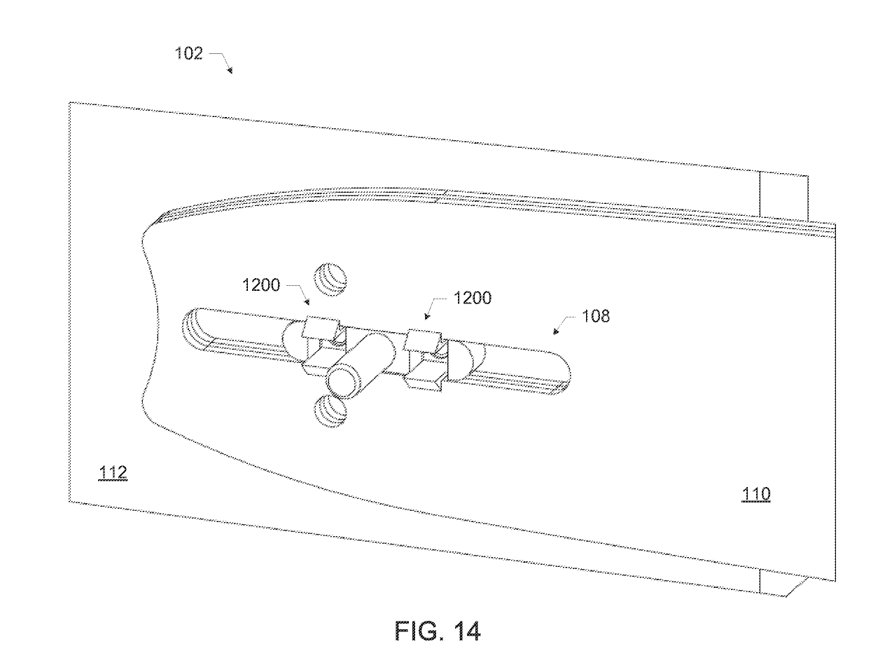

FIG. 14 is a perspective view of the portion of the chainsaw body 102 depicted in FIG. 13, subsequent to mounting the guide bar 110 against the bar mount pad 112, in accordance with various embodiments. When the guide bar 110 is mounted against the bar mount pad 112, the wide portion 1202 of the spring clip 1200 may be compressed such that the width 1206 of the wide portion 1202 is less than or equal to the lateral width 122 of the slot 108. This compression may occur by a user pressing the guide bar 110 against the spring clip 1200 until the legs 1208 and 1210 deform so as to allow the slot 108 to pass over the wide portion 1202 until the guide bar 110 is proximate to the narrow portion 1204 of the spring clip 1200. Once the guide bar 110 is proximate to the narrow portion 1204 of the spring clip 1200, the forces applied to the legs 1208 and 1210 may be reduced, the legs 1208 and 1210 may separate, and the guide bar 110 may be “trapped” between the wide portion 1202 of the spring clip 1200 and the bar mount pad 112. In particular, the guide bar 110 may be “trapped” under the lips 1236 and 1238 of the latches 1232 and 1234, respectively. The guide bar 110 may thus be retained against the bar mount pad 112 so that a user may position a saw chain around the guide bar 110 and perform other desired set up operations without the guide bar 110 “falling off” the chainsaw body 102. Once set up is complete, the user may attach the side cover 114 in the closed configuration.

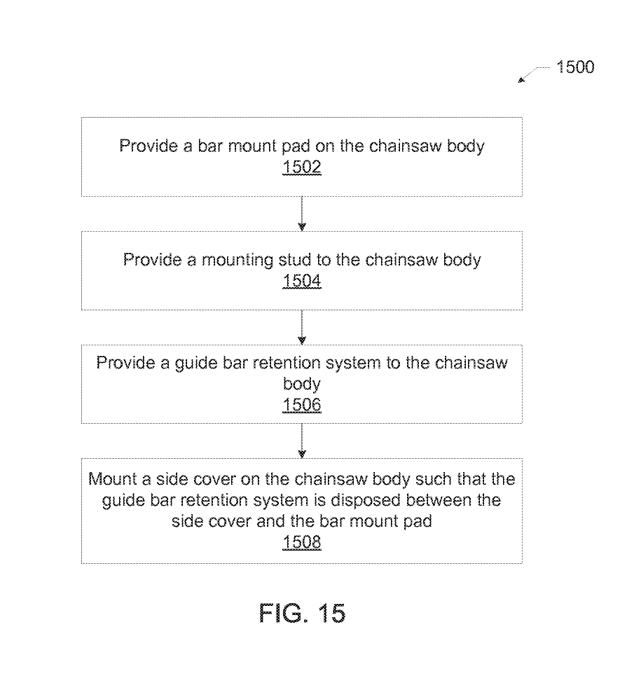

FIG. 15 is a flow diagram of a process 1500 for manufacturing a bar mount portion of a chainsaw body. It may be recognized that, while the operations of the process 1500 (and all other processes disclosed herein) may be arranged in a particular order and illustrated once each, in various embodiments, one or more of the operations may be repeated, omitted, or performed out of order. Any of the operations of the process 1500 may be performed in accordance with any of the embodiments of the chainsaws 150 and the guide bar retention systems 100 described herein.

At 1502, a bar mount pad may be provided on the chainsaw body. For example, the bar mount pad 152 may be formed on the chainsaw body 102.

At 1504, a mounting stud may be provided to the chainsaw body. The mounting stud may extend away from the bar mount pad. For example, the mounting stud 106 may be screwed into a threaded recess in the chainsaw body 102, and may extend away from the bar mount pad 152.

At 1506, a guide bar retention system may be provided to the chainsaw body. For example, any of the guide bar retention systems 100 disclosed herein may be provided to the chainsaw body 102.

At 1508, a side cover may be mounted on the chainsaw body such that the guide bar retention system is disposed between the side cover and the bar mount pad. For example, the side cover 154 may be mounted on the chainsaw body 102 such that any of the guide bar retention systems 100 discussed above with reference to FIG. 1 or 8 are disposed between the side cover 154 and the bar mount pad 152.

In use, after the process 1500, a user may remove the side cover, mount a guide bar and retain the guide bar using any of the guide bar retention systems disclosed herein, attach a saw chain or perform other set up, cleaning or other maintenance operations, then remount the side cover to close the chainsaw prior to performing any sawing operations. The embodiments discussed herein also allow a user to remove the guide bar from the chainsaw after the guide bar has been retained by any of the guide bar retention systems, by reversing the operations described herein for retaining the guide bar. A user may wish to remove a guide bar for cleaning, replacement, or any other desired purpose. Although the systems and techniques disclosed herein have been discussed principally with reference to chainsaws, the retention systems may be applied to any tool in which one component of the tool is to be mounted to another component of the tool and the two components have a tendency to slip apart or otherwise lose engagement during setup. For example, tools with blades (e.g., circular blades) or other similar changeable accessories may benefit from the retention systems disclosed herein (e.g., grinders, circular saws, reciprocating saws, and pruners, among others).

What is claimed is:

1. A chainsaw, comprising:
a mounting stud extending away from a bar mount pad of a chainsaw body, the mounting stud dimensioned to be received in a slot of a guide bar when the guide bar is mounted to the chainsaw body;
a side cover selectively mountable to the chainsaw body in a configuration in which the mounting stud is disposed between the bar mount pad and the side cover;
a guide bar retention system coupled to the chainsaw body and positioned to retain the guide bar against the bar mount pad when the mounting stud is received in the slot of the guide bar and the side cover is not mounted to the chainsaw body;
wherein the guide bar has a first face and an opposed second face, the second face is configured to be disposed between the first face and the bar mount pad when the mounting stud is received in the slot of the guide bar, and the guide bar retention system is configured to apply a force to the first face of the guide bar toward the bar mount pad when the guide bar retention system retains the guide bar against the chainsaw body.

2. The chainsaw of claim 1, wherein the mounting stud comprises a single mounting stud extending from the bar mount pad.

3. The chainsaw of claim 1, further comprising:
a projection extending away from the bar mount pad, wherein the guide bar retention system is coupled to the projection.

4. The chainsaw of claim 3, wherein the guide bar retention system comprises a pin disposed in a hole in the projection, wherein the hole is oriented perpendicular to a direction in which the projection extends away from the bar mount pad.

5. The chainsaw of claim 1, wherein the guide bar retention system comprises a spring clip.

6. The chainsaw of claim 5, wherein the mounting stud extends away from the bar mount pad in a first direction, the spring clip has a wide portion and a narrow portion, and wherein the narrow portion is disposed between the wide portion and the bar mount pad in the first direction.

7. The chainsaw of claim 5, wherein the slot of the guide bar has a longitudinal length and a lateral width, and wherein a width of the spring clip when not under tension is larger than the lateral width of the slot of the guide bar.

8. The chainsaw of claim 5, wherein the guide bar retention system comprises two spring clips.

9. The chainsaw of claim 5, wherein the wide portion comprises a pair of latches.

10. The chainsaw of claim 9, wherein a latch of the pair of latches has a triangular cross-section.

11. A method of manufacturing a bar mount portion of a chainsaw body, comprising:
providing a bar mount pad on the chainsaw body;
providing a mounting stud to the chainsaw body, the mounting stud extending away from the bar mount pad;
providing a guide bar retention system to the chainsaw body; and
mounting a side cover on the chainsaw body such that the guide bar retention system is disposed between the side cover and the bar mount pad,
wherein the guide bar has a first face and an opposed second face, the second face is configured to be disposed between the first face and the bar mount pad when the mounting stud is received in the slot of the guide bar, and the guide bar retention system is configured to apply a force to the first face of the guide bar toward the bar mount pad when the guide bar retention system retains the guide bar against the chainsaw body.

12. The method of claim 11, wherein the guide bar retention system comprises a retention member that is removably coupled to the chainsaw body.

13. The method of claim 11, further comprising:
providing a projection extending away from the bar mount pad, wherein the guide bar retention system comprises a retention member that is coupled to the projection.

14. The method of claim 13, wherein the retention member has first and second legs, the projection has first and second opposing sides, and the retention member is coupled to the chainsaw body such that the first leg of the retention member is disposed proximate to the first side of the projection and the second leg of the retention member is disposed proximate to the second side of the projection.

15. The method of claim 13, wherein the projection includes multiple portions, each portion having a different height with respect to the bar mount pad.

16. The method of claim 13, wherein the projection includes two distinct segments separated by a hole in the bar mount pad.

17. The method of claim 16, wherein the mounting stud is provided in the hole.

18. The method of claim 13, wherein the retention system comprises at least one spring clip.

19. The method of claim 18, wherein the at least one spring clip comprises a pair of latches.
